(19) United States
(12) Patent Application Publication
(10) Pub. No.: US 2023/0392719 A1
(43) Pub. Date: Dec. 7, 2023

(54) Cover For A Pipe

(71) Applicant: Thomas Michael Reese, Elkins Park, PA (US)

(72) Inventor: Thomas Michael Reese, Elkins Park, PA (US)

(21) Appl. No.: 17/834,276

(22) Filed: Jun. 7, 2022

(51) Int. Cl. F16L 9/14

(52) U.S. Cl. CPC F16L 9/14; F16L 57/06

(57) ABSTRACT

A cover for a pipe includes a hollow cylinder having an upper opening and a lower opening defining an interior channel. A flange surrounds the lower opening, such that the flange can be secured to the floor or other surface through which a pipe extends via adhesive fasteners, mechanical fasteners, or the like. The interior channel of the hollow cylinder is configured to receive the pipe therethrough, such that the pipe extends through the upper and lower openings of the hollow cylinder. The hollow cylinder may be rigid or flexible and can be utilized to easily cover exposed plumbing or similar pipes to improve their appearance and provide a more finished look.

### BACKGROUND OF THE INVENTION

The present invention relates to pipe covers. More specifically, the present invention provides a cover for an exposed pipe within a dwelling or other building, whereby the cover is easy to install and provides a more desirable appearance than leaving the pipe exposed.

Plumbing, HVAC, and other pipes are found throughout homes and other dwellings. These and other types of pipes are utilized for transporting water and other materials for various end uses throughout the dwelling. While such pipes are essential to modern living and found virtually everywhere, they are not without drawbacks. Some buildings have exposed pipes that can be considered an eyesore by the occupants. One solution is to enclose the pipes with drywall or other structural installations. However, this can be difficult, expensive, and time consuming for the average homeowner. In instances where is a tenant in a rented property, they may be restricted in how much work they can do to the building, and as such may not be able to add structural features to the premises. If they are permitted to make changes to the dwelling, the tenant may also have to remove such changes if they move out, which can be difficult. Often, the tenant must simply live with the exposed pipes, which can be an annoyance. Some pipes are covered with foam or other insulating materials, but this still leaves an unfinished look. In order to address these concerns, the present invention provides a cover for a pipe that can be easily secured around any type of exposed pipe without the need for additional structural installations.

In light of the devices disclosed in the known art, it is submitted that the present invention substantially diverges in design elements from the known art and consequently it is clear that there is a need in the art for an improvement to existing pipe covering devices, particularly due to the lack of covers for pipes that are easy to install and provide an improved appearance. In this regard the present invention substantially fulfills these needs.

### SUMMARY OF THE INVENTION

In view of the foregoing disadvantages inherent in the known types of pipe cover devices now present in the prior art, the present invention provides a cover for a pipe wherein the same can be utilized to provide an improved appearance over leaving the pipe exposed, which also has features that facilitate easy and non-destructive attachment to the pipe, without requiring additional mounting brackets or other structural installations.

In general, the present invention provides a cover for a pipe that can be utilized to easily and removably cover an exposed pipe. The cover for a pipe includes a hollow cylinder having an upper opening and a lower opening defining an interior channel. A flange surrounds the lower opening and is utilized to secure the cover to a wall, floor, or other surface through which a pipe extends. The flange may include fastener apertures that receive threaded fasteners that can engage corresponding apertures in the wall, floor, or other mounting surface. The flange may alternatively include adhesive materials for easily and removably securing the cover without the need for mechanical fasteners. The interior channel of the hollow cylinder is configured to receive a pipe therethrough, such that the pipe extends through the upper and lower openings of the hollow cylinder. The flange makes flush contact with the support surface so that all areas are covered up and the pipe is no longer exposed. Indicia on the exterior surface of the hollow cylinder can allow the user to customize the overall look of the covered pipe, providing a more finished or aesthetically pleasing appearance to suit their preferences.

One object of the present invention is to provide a cover for a pipe that can be installed with ease with either simple mechanical fasteners or adhesive fasteners, such that the pipe and surrounding area remain undamaged by attachment of the cover.

Another object of the present invention is to provide a cover for a pipe that can improve the aesthetic and provide a more finished look than if the pipe were to remain exposed.

Other objects, features, and advantages of the present invention will become apparent given the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a perspective view of one embodiment of a cover for a pipe according to the present invention.

FIG. 2 shows a perspective view of one embodiment of a cover for a pipe according to the present invention in an open configuration.

FIG. 3 shows a perspective view of another embodiment of a cover for a pipe according to the present invention.

### DETAILED DESCRIPTION OF THE INVENTION

Reference is made herein to the attached figures. For the purposes of presenting a brief and clear description of the present invention, the preferred embodiment will be discussed as used for providing a cover for a pipe that is easy to install and is able to provide a desired aesthetic appearance. The figures are intended for representative purposes only and should not be considered to be limiting in any respect.

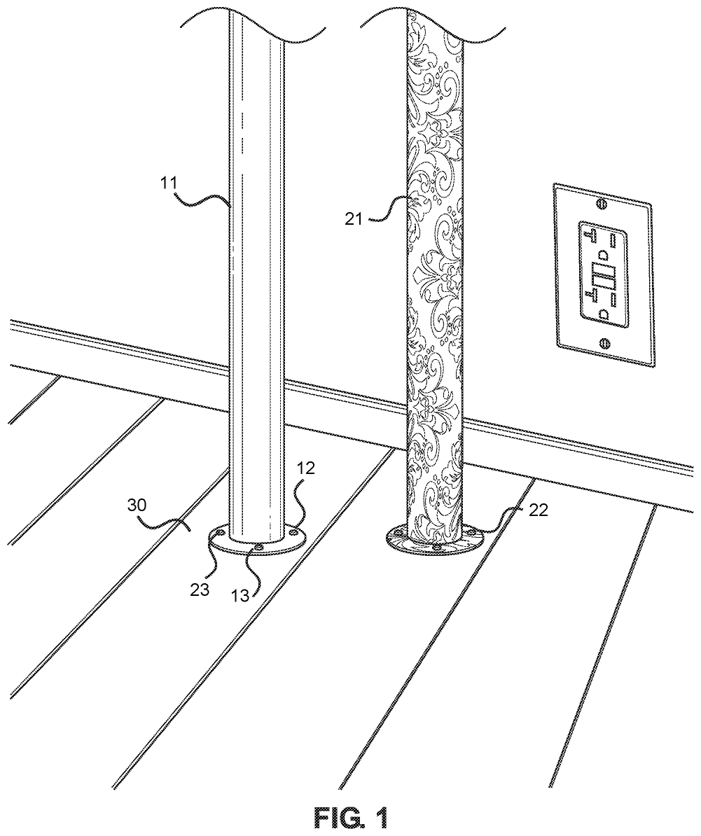

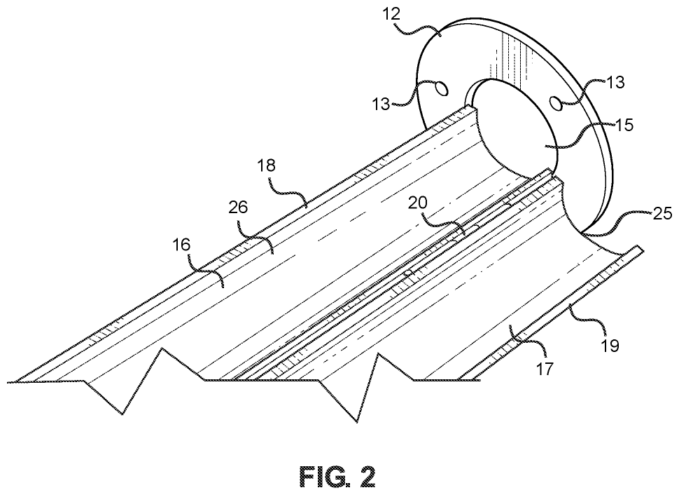

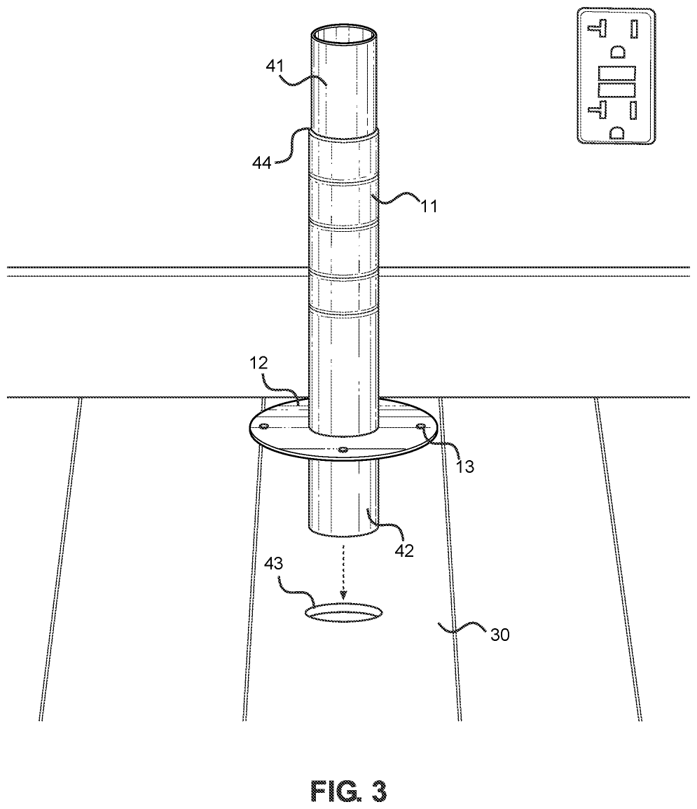

Referring now to FIG. 1, there is shown a perspective view of one embodiment of a cover for a pipe according to the present invention installed on a pipe. There are depicted two versions of the cover; one having a blank or solid outer exterior, and one having indicia 21 thereon, which allows the user to customize the desired appearance of the cover. The cover for a pipe includes a hollow cylinder 11 having an upper opening (annotation 44 in FIG. 3) and a lower opening (annotation 25 in FIG. 2) defining an interior channel (annotation 26 in FIG. 2). The interior channel of the hollow cylinder is configured to receive a pipe therethrough, such that the pipe extends through the upper and lower openings of the hollow cylinder 11, which is demonstrated in FIG. 3.

A flange 12 surrounds the lower opening 25 of the cover 11, which is utilized to support the cover 11 on the floor 30 or other surface through which the pipe extends. In one embodiment, the flange 12 includes apertures 13 that can receive threaded fasteners, such as screws for example, or any other suitable mechanical fastener, which secures the flange 12 to the surface through which the pipe extends and provides additional support for the cover 11. In other embodiments, the flange 12 may include adhesive material on the lower side thereof, such that the flange can removably secure to the floor 30 or other surface. Further, in the shown embodiments, the flange 12 includes a circular outer perimeter edge, which improves the stability of the cover and reduces material costs.

The lower surface of the flange 12 may align flush with the lower opening of the hollow cylinder, such that the flange bears the weight of the cover. However, as shown in FIG. 3, the flange 12 may also be positioned further up the height of the cover. Additionally, the flange 12 extends outwardly from the hollow cylinder 11 at a perpendicular angle to maximize the effectiveness of the flange 12 supporting the cover 11.

Referring now to FIG. 2, there is shown a perspective view of one embodiment of a cover for a pipe according to the present invention in an open configuration. In the shown embodiment, the hollow cylinder 11 is composed of a rigid material, which can provide protection to the pipe and also has the benefit of being a stiffer structural support. In other embodiments, the hollow cylinder 11 is composed of a flexible material, so that it can wrap around the pipe closely and secure thereto with an adhesive material disposed within the interior channel 26 of the hollow cylinder.

In the shown embodiment demonstrating a more rigid cover, the hollow cylinder 11 includes a first half 16 that is pivotally secured to a second half 17 via one or more hinges 20, such that the hollow cylinder 11 is movable between an open configured, as shown in FIG. 2, and a closed configuration, as shown in FIG. 1. This allows the cover to be easily installed around pipes that are already installed and exposed within the building. The flange 12 includes an opening 15 that is sized to receive the pipe therethrough. To provide a more secure attachment and improved appearance, the first and second halves 16, 17 of the hollow cylinder are generally symmetrical. The edges 18, 19 of the first and second halves 16, 17 are planar, such that the edge 18 of the first half 16 of the hollow cylinder 11 makes continuous contact with an edge 19 of the second half 17 of the hollow cylinder 11 when the hollow cylinder 11 is in the closed configuration. This provides a more finished appearance and a better fit and securement around the pipe.

In some embodiments, the interiors of the first and second halves 16, 17 include an adhesive material to removably secure the hollow cylinder around the outer surface of the exposed pipe. In the shown embodiment, the first half 16 of the hollow cylinder is affixed to the flange 12, and the second half 17 of the hollow cylinder is disconnected from the flange 12. This allows for the flange 12 to be installed or positioned first to support the weight of the cover before then closing the disconnected half to seal the cover around the pipe.

Referring now to FIG. 3, there is shown a perspective view of another embodiment of a cover for a pipe according to the present invention. In the shown embodiment, the hollow cylinder 11 is made with a more a flexible material, such that it can be wrapped around and conform to the pipe 41, securing thereto via adhesive or other fasteners. The upper end 44 of the cylinder 11 can reach to the area where the pipe extends through a wall, ceiling, or other surface, or it can leave a portion of the pipe exposed if desired. In the shown embodiment, the lower end 42 of the cover extends downwardly below the flange 12, such that a portion of the cover can enter the opening 43 in the floor 30. This also helps to secure the cover in place and can be used to maintain a seal around the opening 43, preventing potential leaks. The mounting apertures 13 on the flange 12 can then be utilized to further secure the cover in place if needed.

It is therefore submitted that the present invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A cover for a pipe, comprising:
a hollow cylinder having an upper opening and a lower opening defining an interior channel;
a flange surrounding the lower opening;
wherein the interior channel of the hollow cylinder is configured to receive a pipe therethrough, such that the pipe extends through the upper and lower openings of the hollow cylinder.

2) The cover for a pipe of claim 1, further comprising an adhesive material disposed on an interior surface of the hollow cylinder.

3) The cover for a pipe of claim 1, further comprising an adhesive material disposed on a lower surface of the flange.

4) The cover for a pipe of claim 1, further comprising a plurality of fastener apertures disposed on the flange.

5) The cover for a pipe of claim 4, wherein each fastener aperture is threaded and configured to removably secure a threaded fastener therethrough.

6) The cover for a pipe of claim 1, wherein the hollow cylinder is composed of a flexible material.

7) The cover for a pipe of claim 1, wherein the hollow cylinder is composed of a rigid material.

8) The cover for a pipe of claim 1, further comprising indicia disposed on an exterior surface of the hollow cylinder.

9) The cover for a pipe of claim 1, wherein a lower surface of the flange aligns flush with the lower opening of the hollow cylinder.

10) The cover for a pipe of claim 1, wherein the hollow cylinder includes a first half that is pivotally secured to a second half via one or more hinges, such that the hollow cylinder is movable between an open configured and a closed configuration.

11) The cover for a pipe of claim 10, wherein an edge of the first half of the hollow cylinder makes continuous contact with an edge of the second half of the hollow cylinder when the hollow cylinder is in the closed configuration.

12) The cover for a pipe of claim 10, wherein the first half of the hollow cylinder is affixed to the flange, and wherein the second half of the hollow cylinder is disconnected from the flange.

13) The cover for a pipe of claim 10, wherein the first half of the hollow cylinder is symmetrical with the second half of the hollow cylinder.

14) The cover for a pipe of claim 1, wherein the flange extends outwardly from the hollow cylinder at a perpendicular angle.

15) The cover for a pipe of claim 1, wherein the flange includes a circular outer perimeter edge.
